(19) United States
(12) Patent Application Publication
(10) Pub. No.: US 2018/0278989 A1
(43) Pub. Date: Sep. 27, 2018

(54) APPARATUS AND METHOD FOR EVENT TRIGGERING FROM AUDIO CONTENT DIGITAL ID

(71) Applicant: SCREEN JUMPER, Saint-Lambert (CA)

(72) Inventors: Yves D'AOUST, Saint-Lambert (CA); Martin BENOIT, Saint-Jean-sur-Richelieu (CA)

(21) Appl. No.: 15/762,008

(22) PCT Filed: Oct. 3, 2016
(86) PCT No.: PCT/CA2016/051149

§ 371 Date: Mar. 21, 2018

Related U.S. Application Data
(60) Provisional application No. 62/236,401, filed on Oct. 2, 2015.

(51) Int. Cl. H04N 21/442; H04N 21/41; H04N 21/439

(52) U.S. Cl. CPC H04N 21/442; H04N 21/439; H04N 21/4104

(57) ABSTRACT

The present document describes an apparatus and method for monitoring and interacting with listeners of audio-video content. There are provided audio signals from which audio-video content can be identified by a monitoring peripheral paired with a user's electronic device. The monitoring peripheral monitors audio signals from its surroundings and communicates to the paired user's electronic device, decoded and/or generated digital IDs from these audio signals. A master service application or registered service application miming on the electronic device could transmit the digital ID to a remote server and retrieve additional information from these digital IDs with or without the use of a backend system. Events could be triggered and relevant audio-video content be presented to the user of the master service application or a registered service provider when digital IDs are received from the monitoring peripheral.

### BACKGROUND

### (A) Field

The subject matter disclosed generally relates to audio content identification. More specifically, it relates to audience monitoring and linkage of specific audio-video content to a service provider application or web service.

### (b) Related Prior Art

There is described herein a system and a method for monitoring and interacting with viewers of audio (or video) content. Existing systems use information embedded in the audio-video content (usually referred to as a watermark) to identify what is being listened to by a user.

Some interesting opportunities arising when watermarks or fingerprints are detected and other content are presented to the user, or to collect data about the user habits. Providing information to a device (TV, tablet, smartphone, etc.) and connecting to a remote server may be necessary.

Prior art systems attempting to form a link between a client device and a remote server based on the audio content being listened to by a consumer having that client device usually make use of an application installed on the client device (e.g., a smartphone) that listens to the audio content, looking for a watermark. For example, in US patent application 2012/0203559 A1, the computing device (e.g., smartphone) needs to constantly listen to the surrounding audio signals. The same applies to US patent application 2015/0193899 A1 and U.S. Pat. No. 8,666,528 B2. Having a smartphone or tablet listen to audio signals is disadvantageous for various reasons. It implies that a dedicated application on the device needs to be open to listen to the audio signals, which is inconvenient for the user and may cause lost opportunities since the dedicated application will more often than not be closed. Otherwise, a background function may listen to audio signals in background. This alternative involves privacy concerns and further consumes energy on the device. None of these documents discuss providing a low-energy device listening to audio signals and waking up an application on a phone when some criteria are met.

U.S. Pat. No. 7,533,266 B2 describes a “verifying device” which does not “wake up” any application on the computer to which it is connected. Furthermore, in this document, the computer does not even connect to a remote server.

There is therefore a need for a device that would take the audio listening burden away from smartphones/tablets. There is further a need for a hardware system detecting audio content watermarks or fingerprint that would be adapted to better preserve privacy of the viewer compared to prior art systems, while also being adapted to provide the viewer with a variety of applications making use of the detected audio content watermark or fingerprint.

### SUMMARY

According to an embodiment, there is provided a method of interacting with users of audio-video content. The method comprises: providing a monitoring peripheral for detecting audio signals and an electronic device having a master service application installed thereon; detecting a proximity between the monitoring peripheral and the electronic device; upon detecting the proximity, activating the master service application; providing audio signals containing the audio-video content to be played back, the audio-video content comprising digital IDs; detecting, by the monitoring peripheral, the digital IDs and sending a signal containing the digital IDs to the electronic device having the master service application thereon.

According to an aspect, the audio-video content is generated by a remote content server in connection with an authorization server to authorize the remote content server to broadcast the audio-video content to at least one of the users, further comprising pairing the master service application to the monitoring peripheral by providing an authorization communication between the electronic device and the authorization server.

According to an aspect, the method further comprises retrieving, by the master service application, additional information for the digital IDs on a local application installed on the electronic device other than the master service application.

According to an aspect, the method further comprises retrieving, by the master service application, additional information for the digital IDs from a remote backend system.

According to an aspect, the method further comprises sending by the remote backend system to the electronic device a communication related to the digital IDs.

According to an aspect, a selected portion of the audio-video content is identified by a selected digital ID.

According to an aspect, the selected portion of the audio-video content identified by the selected digital ID comprises a portion of the audio-video content that advertises a selected product and retrieving, by the master service application, additional information for the selected digital ID comprises retrieving information related to the selected product.

According to an aspect, the method further comprises monitoring the digital IDs to detect when the audio-video content relates to a registered service provider.

According to an aspect, the method further comprises notifying the master service application in response to a detection of a digital ID that relates to the registered service provider in the step of detecting digital IDs step.

According to an aspect, the method further comprises notifying, by the master service application, the registered service provider, triggering the registered service provider to generate a communication related to the audio-video content identified by the digital ID that relates to the registered service provider, the communication being directed to the electronic device or to a remote server.

According to an aspect, a selected portion of the audio-video content is identified by a selected digital ID and further wherein if the communication is directed to the electronic device, the communication comprises a call-to-action message associated with the selected portion of the audio-video content identified by the digital ID.

According to an aspect, the method further comprises receiving, by the master service application, a deactivation signal for a given registered service provider on the electronic device, and in response to the deactivation signal the monitoring the digital IDs is not performed for the given registered service provider.

According to an aspect, each of the digital IDs is at least one of a fingerprint, a watermark, embedded data inside the audio-video content, and embedded data in a transmitting envelope of the audio signals.

According to an embodiment, there is provided an apparatus for monitoring audio-video content. The apparatus comprises: an input for detecting audio signals of the audio-video content which comprises a digital ID; a processing unit for decoding the digital ID; a beacon to broadcast a presence of the apparatus to an electronic device; and a short range wireless device to transmit the digital ID to the electronic device if the electronic device is nearby; and wherein the apparatus is adapted to communicate with a master service application on the electronic device, the master service application being adapted to communicate with a remote backend system to retrieve additional information related to the digital ID.

According to an aspect, the electronic device comprises an input and an application, the short range wireless device being adapted to communicate with the input of the electronic device to send the digital ID detected in the audio-video content for use by the application.

According to an aspect, the apparatus is provided substantially as a USB peripheral.

According to an aspect, the USB peripheral is connectable to a set-top box which manages the audio-video content in which the audio signals are detected.

According to an aspect, the apparatus is provided as an internal part of a set-top box which manages the audio-video content in which the audio signals are detected.

According to an aspect, the input for detecting audio signals is a microphone.

According to an aspect, the digital ID is at least one of: a fingerprint, a watermark, embedded data inside the audio-video content, and embedded data in a transmitting envelope of the audio signals.

According to an embodiment, there is provided an apparatus for interacting with viewers of audio-video content and a method therefor. The method comprises providing signals containing audio-video content to be played back, selected portions of the audio-video content being identified by a digital ID such as fingerprints, watermarking or any embedded digital data with the audio content or stream; transmitting such a digital ID in audio signals (aka sound signals) over the audio frequency of the content source (or outside of the content spectrum, as long as the frequency of the digital ID can be detected successfully); a peripheral detecting such digital ID within range of the transmitter, the peripheral advertising its service (i.e., indicating its presence) using standard beacon technology, a subscribing user's mobile device detecting such beacon and activating a master service application, the master service application connecting to the monitoring peripheral using a wireless connection, such as Bluetooth technology, the monitoring peripheral transmitting to the master service application all detected digital IDs. The master service application generating events detection on a subscribing user's mobile device upon receiving digital IDs; the detection event triggering relates to (a) the master service application, b) a service provider application identified by the subscriber user as an application of interest and such application has registered with the master service provider service and (b) the master service provider has a digital ID that matches a locally or remotely stored digital ID or notifying a registered service provider application in response to the detection of digital ID.

The monitoring peripheral provides automatic activation and deactivation based on the proximity of the subscribing user's mobile device to the peripheral. In other words, the monitoring peripheral shall only provide specific information when the user (with their mobile device) is inside the context of the audio-video device vicinity. Upon deactivation due to the mobile device being moved away a threshold distance of a few meters, the peripheral will no longer notify the user of any detected digital IDs.

The selected portions of the audio-video content identified by digital IDs may include any portion of the audio-video content such as but not limited to advertising, and the communication transmitted to the registered service provider application relates to such identified advertising.

The monitoring of the audio-video playback may be achieved by automatic content recognition technologies, by fingerprinting technologies, by watermarking technologies or any private or standard methods.

According to a first aspect of the invention, there is provided a method of interacting with users of audio-video content, the method comprising: activating a master service application on an electronic device; pairing the master service application with a monitoring peripheral; sending, by the electronic device, an authentication request to a backend system and receive a confirmation therefrom; providing audio signals as part of an audio-video content to be played back, selected portions of the content being identified by digital IDs; detecting a proximity between the monitoring peripheral and the electronic device having the paired master service application thereon; activating the master service application; sending, by the monitoring peripheral, the digital IDs to the electronic device having the paired master service application thereon; and sending, by the master service application, the digital IDs to a remote backend system or to a local system in the electronic device.

According to an embodiment, there is further provided monitoring of digital IDs from audio playback and detecting when the played audio-video content relates to at least one of: the master service application or a registered service provider;

According to an embodiment, there is further provided notifying the master service application in response to the detection of a digital ID that relates to the master service application or a registered service provider.

According to an embodiment, there is further provided transmitting to the paired user a communication related to the digital ID.

According to an embodiment, providing audio signals comprises providing audio signals as part of an audio-video content, selected portions of the audio-video content being identified by at least one of: a fingerprint, a watermark, embedded data inside the audio content, and embedded data in a transmitting envelope of the audio signals.

According to an embodiment, there is further provided receiving, by the master service application, a deactivation signal for a registered service provider from the paired user, and in response to the deactivation signal the registered service provider monitoring, notifying and transmitting are not executed.

According to an embodiment, the selected portions of the audio-video content identified by digital IDs include a portion of the audio-video content that advertises a selected product, or displays scenes of interest and the communication transmitted to the paired user relates to the selected product.

According to an embodiment, the monitoring of the audio-video playback is achieved by a monitoring peripheral device running a digital ID software such as automatic content recognition, watermarking reader. Fingerprinting reader or any other form of software capable of uniquely identified a digital ID audio content segment.

According to an embodiment, the monitoring peripheral is able to advertise its presence to nearby electronic devices where the electronic devices activate a master service application upon detecting the monitoring peripheral advertisement identifier from the monitoring peripheral.

According to an embodiment, the paired user of the master service application is able to connect to the monitoring peripheral and receive the digital ID from the monitoring peripheral.

According to an embodiment, the paired user is a user that has authorized the master service application to receive, process, and transmit to a remote backend system or local system on the electronic device by the paired user electronic device the digital ID.

According to an embodiment, the master service application can register a service provider application and associate the registered service provider application with selected portion of the audio-video content identified by the digital ID.

According to an embodiment, the registered service provider can receive a notification by the master service application or its backend service and generates communication transmitted to the paired user or backend service related to the audio-video content identified by the digital ID.

According to an embodiment, the communication transmitted to the paired user includes a call-to-action associated with the selected portion of the audio-video content identified by the digital ID.

According to an embodiment, the digital IDs are at least one of digital fingerprints, watermarks and digital data embedded with the audio signals.

According to another aspect of the invention, there is provided a system for interacting with viewers of audio and audio-video content, the system comprising: a source of audio signals as part of an audio-video content, such content being identified by a digital ID; an electronic device comprising a master service application as a main service provider, data from a paired user, and a registered service provider application activated by the master service application, the master service application being for receiving the digital ID and detecting when the digital ID (a) relates to a registered service provider activated by the paired user; or (b) has a digital ID that matches a known digital ID associated to that registered service provider; and a backend system adapted to notify a registered service provider in response to the detecting by the master service application and to transmit to the electronic device a communication related to the digital ID.

According to an embodiment, the backend system receives a deactivation signal from the paired user for a registered service provider, and in response to the deactivation signal disables the monitoring, processing and transmitting operations for the deactivated registered service provider.

According to an embodiment, the selected portions of the audio-video content identified by digital ID include a portion of the audio-video content that advertises a selected product, or content sequences of interest and the communication transmitted to the paired user relates to the selected product or sequences.

According to an embodiment, the paired user is a user that has authorized the monitoring, processing, notifying and transmitting for the specified registered service provider upon connection to the monitoring peripheral.

According to an embodiment, the electronic device of the paired user contains an app that enables receipt from the monitoring peripheral a digital ID of the transmitted communication of the played audio-video content.

According to an embodiment, the registered service provider is associated with the selected portion of the audio-video content identified by the matched digital ID.

According to an embodiment, the communication transmitted by the backend service or master service application to the paired user includes a call-to-action associated with the selected portion of the audio-video content identified by the matched digital ID.

According to an embodiment, the digital IDs are at least one of: digital fingerprints, watermarks and digital data embedded in the audio signals.

According to an embodiment, the monitoring peripheral can be in three different states: standby, connected and disconnected. When in standby state, the monitoring peripheral is powered, is advertising its beacon ID and is waiting for connection. When in connected state, the monitoring peripheral is connected to a paired electronic device, digital ID detection is enabled and the monitoring peripheral can transmit digital IDs to connected paired electronic devices. When disconnected, the monitoring peripheral will no longer transmit digital IDs but detection could remain enabled for a configured period of time before going into the standby state.

As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a diagram illustrating a system comprising a backend system of a service provider, in relation with a monitoring peripheral and an electronic device comprising a master service application and registered service providers' applications, according to an embodiment;

FIG. 2 is a diagram illustrating a system comprising a backend system of a service provider, in relation with a monitoring peripheral and an electronic device comprising a master service application for registered service providers' applications, according to an embodiment;

FIG. 3 is a flowchart illustrating a method of using a monitoring peripheral and an electronic device comprising a master service application, according to an embodiment; and

FIG. 4 is a top view illustrating a monitoring peripheral, according to an embodiment.

It will be noted that throughout the appended drawings, like features are identified by like reference numerals.

### DETAILED DESCRIPTION

The emergence of mobile applications (also known as apps) makes it possible for the viewer to interact and engage with TV and radio content such as programming and advertising. A direct coordination between a mobile app and a TV or radio content is made possible using a monitoring peripheral combined with digital IDs and Bluetooth technology integrated into this monitoring peripheral. Of course, Bluetooth technology is only an example of a type of short range wireless communication technology. Other types of short range wireless devices and technologies are used according to other embodiments.

The monitoring peripheral could be a device chosen, without limitation, from the following: a custom peripheral, a mobile device, a connected TV or a set-top box. According to an embodiment, the monitoring peripheral uses Bluetooth and beacon technologies to broadcast its availability to devices such as mobile phones and tablets and uses wireless protocols to communicate detected digital ID part of an audio/video content to a master service application installed on that mobile or tablet device. Upon receiving the digital ID, the master service application can communicate with the event notification backend system (backend system) or locally with other applications installed on the mobile or tablet device. After receiving a specific digital ID, the master service application can react according to predefined business rules (i.e., steps known as “business logic” performed by the system to offer a service to a customer). The definition of these business rules is not part of the scope of this document but could be to have a message (e.g., a push message) be displayed on the TV, or create events on the user electronic device (e.g., smartphone, tablet, or any handheld connected devices), directly inside the app itself, or through messages to a third party backend service. The use of Bluetooth and beacon technologies allows the master service application to be launched only when needed and to activate the communication with the monitoring peripheral, thus allowing the master service application to provide additional information based on digital IDs found in the audio only when the user is in the presence of that audio-video content and nearby the monitoring peripheral.

The problem with existing solutions is that they offer no reliable relationship between the audio-video content displayed on the television or heard on the radio and the user's proximity to the TV or radio and live interest when exposed to the audio content. Existing solutions also offer no explicit privacy protection to the viewer. With the use of audio-video content recognition (ACR), audio fingerprinting or audio watermark inside smartphones or tablets, existing solutions are limited to one application actively running on the device and using its microphone to receive the audio signal. Existing ACR solutions require significant cloud server infrastructure to support the amount of live triggers on broadcast content, with limited viewer control over the activation and deactivation of monitoring and personalized graphic overlays.

The term “user” is used herein to describe a radio listener, TV viewer/consumer, or subscriber of a service provider. The terms “monitoring peripheral” are used herein to describe a device that detects digital IDs from audio signals, and make uses of wireless and beacon technologies to filter and communicate these digital IDs based on the user's proximity to that device. The terms “master service application” used herein correspond to a mobile application using the mobile SDK and therefore capable of communicating with a monitoring peripheral and receiving the digital IDs. The terms “mobile SDK” used herein correspond to the set of libraries used to communicate with the backend system, the monitoring peripheral and the mobile application. The term audio/video device is used herein to describe a playback device of broadcast, on-demand audio or video content, such as a television, radio, mobile, tablet, monitor, or any combination thereof. The terms “registered service provider” are used herein to describe mobile applications from retailers, brand manufacturers, advertisers, agencies, TV programmers, producers and network operators or any combination thereof for which the application has been registered on the backend system to be notified of detected digital IDs.

The term “electronic device” is used herein to describe a mobile device, tablet, smartphone or any handheld connected devices.

The term “beacon” used below refers to device enabling the iBeacon™ technology, commercialized by Apple Inc., the Eddystone technology commercialized by Google Inc., or an equivalent thereof. The beacon thus refers to these devices (or transmitters) that work using Bluetooth low energy technology to broadcast an identifier to nearby portable electronic devices such as smartphones. The beacon uses Bluetooth low energy proximity sensing to broadcast its identifier around it; the signal that is transmitted can be picked up by an app or by the operating system (OS) of the electronic device. Events can thus be triggered on a portable electronic device even though no action is performed on the portable electronic device by the user. Moreover, the portable electronic device does not have to be “listening” to (or “monitoring”) its environment; the beacon actively communicate its presence to the portable electronic device.

The digital ID embedded in the audio signal can be a sound signal provided in the audible spectrum (i.e., in the 20 Hz to 20 kHz range), or in the inaudible spectrum, as long as the sound detector (i.e., microphone) provided in the apparatus (i.e., the monitoring peripheral) can detect the sound frequency in which the digital ID is embedded.

There is a need for software running on a monitoring peripheral in order to support the different monitoring technologies and the peripheral interactions with the user.

Registered service providers can make use of the mobile software development kit (mobile SDK) to enable their mobile application to use monitoring peripherals, thus eliminating additional steps to their users to activate the service.

One embodiment described herein has three components: a monitoring peripheral, an electronic device having a mobile SDK installed thereon, and a backend system. The monitoring peripheral uses wireless communication and beacon technologies in order to be discovered by the mobile SDK (and therefore be discovered by a master service application too) and to notify of detected digital IDs. More precisely, the proximity of the electronic device to the monitoring peripheral will have the beacon provided in the monitoring peripheral “wake up” a master service application on the electronic device. The electronic device can then connect to the monitoring peripheral and start receiving digital IDs decoded information from the audio signal to the electronic device, either spontaneously or after having been requested by the electronic device. More generally, once a user's mobile application on the electronic device is connected to a monitoring peripheral, the mobile SDK may generate local event notifications, monitor different activities and send event notifications to the backend system based on detected digital IDs.

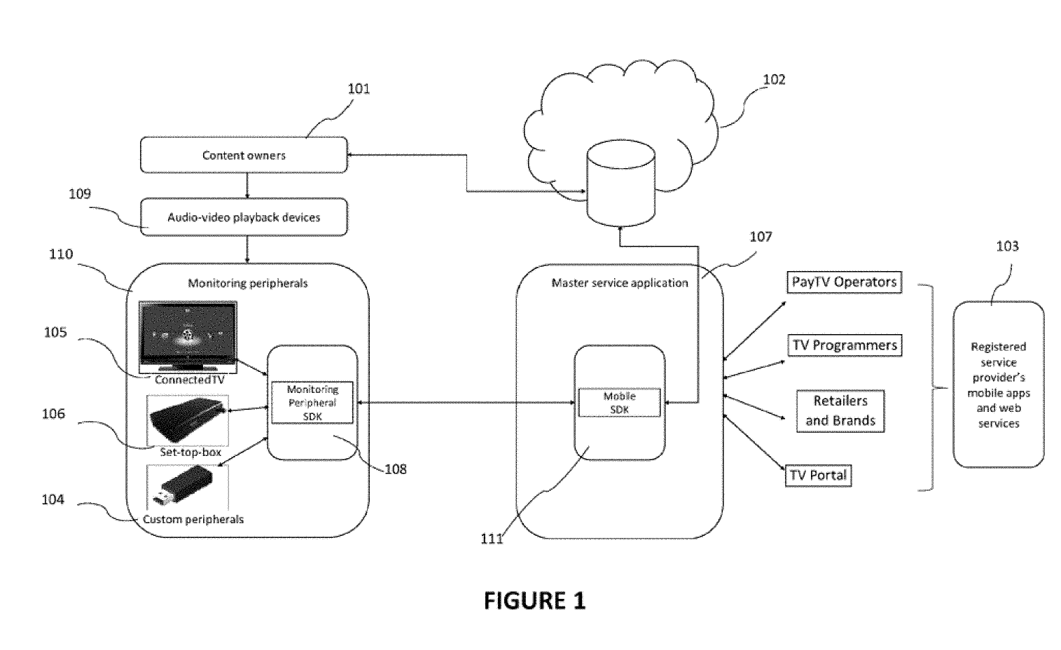

In FIG. 1, the relationship between illustrated components shows how the backend system operates, according to an embodiment. Content owners 101 communicate with the backend system 102 for content ingestion, digital ID, content management, delivery and monitoring, and deliver to the user their content integrating digital IDs through audio-video playback devices 109. The backend system 102 communicates with the mobile SDK 111 used by the master service application 107 for content instructions and management and user pairing to the monitoring peripheral 110. The pairing process to create the link between the master service application and monitoring peripherals 110 is done using short range wireless pairing protocols such as Bluetooth and mobile OSes specifics. Once the pairing process completed, the mobile SDK 111 sends back the monitoring peripheral ID to the backend system 102. At this point, all paired monitoring peripherals 110 can start detecting digital IDs from the audio signal of audio-video playback devices 109 and the monitoring peripheral SDK 108 will be notifying of these digital IDs to their paired mobile device's mobile SDK 111. The mobile SDK 111 will then execute content instructions and notify registered service provider applications 103 and the backend system 102 accordingly.

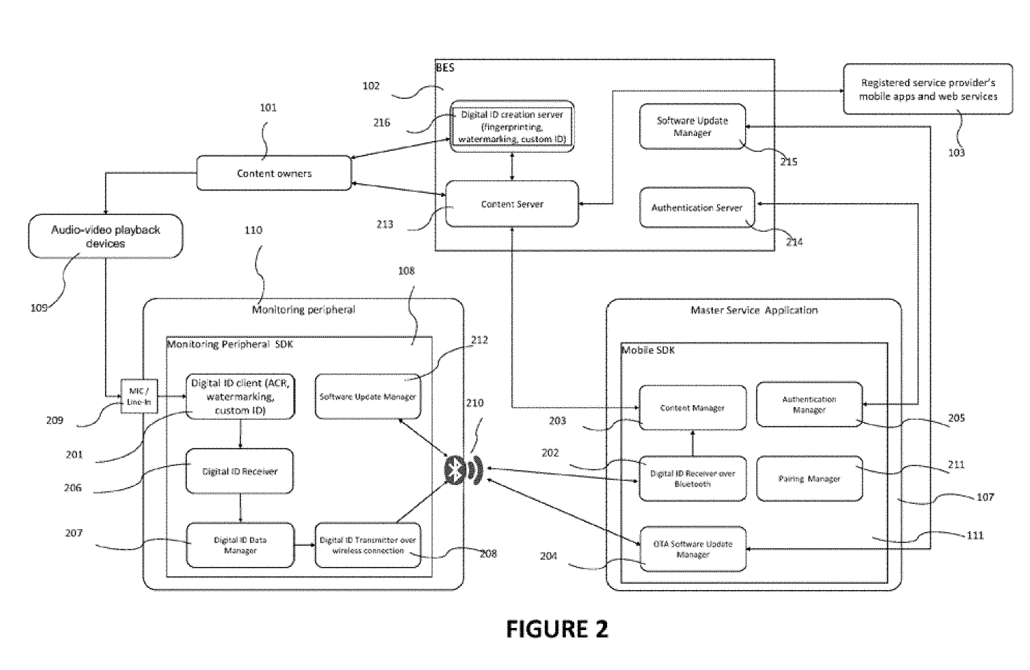

In FIG. 2, the plurality of relationships between the mobile SDK 111, the registered service provider mobile applications 103 and content owners 101 is shown in relation to the backend system 102. The backend system 102 connects to the mobile SDK 111 through the content and authentication servers. Registered service provider mobile applications 103 connect to the backend system 102 through the content server 213. The monitoring peripheral SDK 108 is integrated in the monitoring peripheral devices 110. Monitoring peripherals 110 receiving, using a microphone or line-in 209, content owners' digital IDs from audio-video playback devices 109 and transmitting these digital IDs to the master service application 107 through the monitoring peripheral SDK 108 and mobile SDK 111. The mobile SDK 111 provides: pairing 211 to a monitoring peripheral, user authentication 205 to the backend system, digital IDs data receiver 202, monitoring peripheral activation triggered by proximity detection using Bluetooth short range wireless device 210 and beacon protocol, manage audio-video content associated with received digital IDs and manage monitoring peripheral OTA software updates 204. The backend system 102 can associate one or more service from registered service provider mobile apps and web services 103. The backend system 102 can provision and manage audio-video contents for one or more registered service provider applications and web services. The monitoring peripheral SDK provides: detection of digital ID client 201 and reception 206, digital ID management 207, transmission over wireless connection 208 and over-the-air (OTA) software update 212.

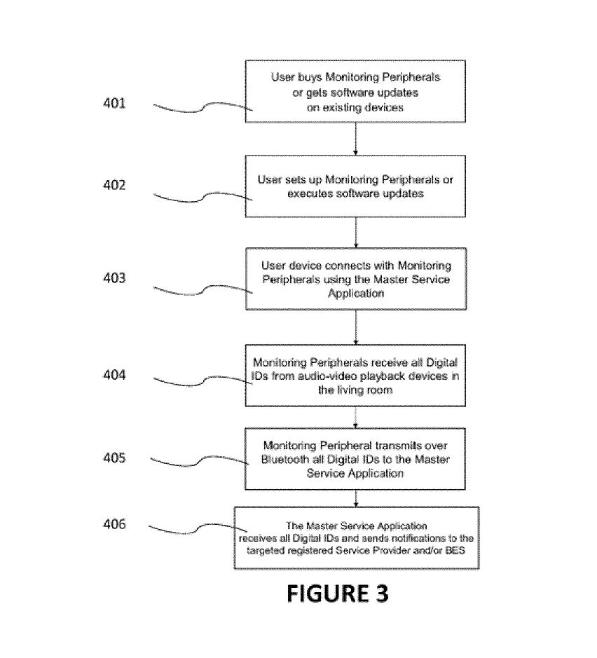

In FIG. 3, an example of using the backend system from the perspective of a user monitoring peripheral 110 who has the ability to run the monitoring peripheral SDK 108 software. The process begins with the user providing a new monitoring peripheral or installing a software update on their existing monitoring peripheral (step 401). The user then sets up the new monitoring peripheral 110 or executes the software update on their existing monitoring peripheral (step 402). In step 403, the user device connects the master service application to that monitoring peripheral 110 using short range wireless device 210 or an equivalent wireless connection. In step 404, the monitoring peripheral 110 receives all digital IDs from audio-video playback devices in the living room, for example. The monitoring peripheral 110 then transmits digital IDs to the master service application 107 over the Bluetooth connection 210 (step 405). The master service application eventually receives all digital IDs and sends notifications to targeted registered service providers and to the backend system based on content instructions (step 406).

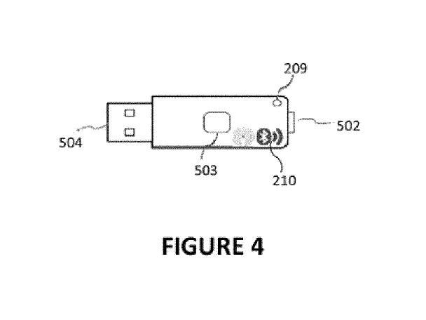

FIG. 4 shows an embodiment of a monitoring peripheral. There is shown a USB device 504 that comprises a microphone 501, a status LED 502 and a button 503, used primarily for pairing, and a Bluetooth connection 210 that is beacon-enabled. This device makes use of the monitoring peripheral SDK 108 and is capable of detecting and accumulating digital IDs received from audio-video playback devices 109, to transmit the digital IDs over wireless connection 208 to a master service application 107 integrating the mobile SDK 111.

Based on content instructions, and according to an embodiment, registered service providers receive event notifications, triggered by digital ID detections, from the master service application or the backend system, the master service application or registered service providers may react from notification with a variety of call-to-action signals, such as sending a notification to the user's mobile hosting the registered service application or computer-based service, or updating the user's shopping basket or shopping list or service data or social media actions, engagement or taking an action relating to a request for more information about a product or service by email, SMS, etc., or for the download of another mobile app or file including but not limited to coupons, offers, music, video, podcasts, or any events can be fulfilled by an action that is taking through a mobile app or web service. The master service application 107 may also just monitor service provider's related digital IDs and report playback activities to backend system 102 who prepares information reports to the service provider's backend system.

Content owners 101 audio-video assets are assigned digital IDs (identifications such as watermarking, fingerprinting or custom ID value) and those digital IDs distributed to the user using audio-video playback devices 109 and accessible by the monitoring peripheral SDK 108 to be detected by digital ID client 201. Content owners 101 without mechanism to assigned digital IDs can use backend system 102 custom ID system to identify their audio-video assets. The monitoring peripheral 110 will then be able to receive such digital ID using standard data transmission demodulation techniques in the audible spectrum, process and package the digital IDs and transmit such packaged digital IDs to the master service application 107 over the monitoring peripheral 110 wireless connection. The mobile SDK 111 detects a monitoring peripheral 110 using Bluetooth and beacon protocols identification is triggering the user mobile device operating system to start the master service application 107 digital ID data receiver 202 which begins receiving digital IDs over wireless. The received digital IDs over wireless are analyzed by the Content Manager 203. The content manager 203 notifies the master service application 107 and the backend system 102 of that digital ID. The master service application 107 or the backend system 102 content server 213 (aka the remote content server) notifies the registered service provider backend who could generate its call-to-action signal and send an appropriate notification to the user through its mobile application or web service. In other embodiments, the master service application 107 or the backend system 102 may take responsibility and send the notification directly to the registered service provider application 103. According to an embodiment, the backend system 102 is not remote; it is then considered as a local system.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well-known manner (e.g., it may be implemented by an application specific integrated circuit (ASIC), a programmable logic device (PLD), a field programmable logic device (FPLD), discrete logic, etc.). Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A method of interacting with users of audio-video content, the method comprising:
providing a monitoring peripheral for detecting audio signals and an electronic device having a master service application installed thereon;
detecting a proximity between the monitoring peripheral and the electronic device;
upon detecting the proximity, activating the master service application;
providing audio signals containing the audio-video content to be played back, the audio-video content comprising digital IDs;
detecting, by the monitoring peripheral, the digital IDs and sending a signal containing the digital IDs to the electronic device having the master service application thereon.

2. The method of claim 1, wherein the audio-video content is generated by a remote content server in connection with an authorization server to authorize the remote content server to broadcast the audio-video content to at least one of the users, further comprising pairing the master service application to the monitoring peripheral by providing an authorization communication between the electronic device and the authorization server.

3. The method of claim 1, further comprising retrieving, by the master service application, additional information for the digital IDs on a local application installed on the electronic device other than the master service application.

4. The method of claim 1, further comprising retrieving, by the master service application, additional information for the digital IDs from a remote backend system.

5. The method of claim 4, further comprising sending by the remote backend system to the electronic device a communication related to the digital IDs.

6. The method of claim 4, wherein a selected portion of the audio-video content is identified by a selected digital ID.

7. The method of claim 6, wherein the selected portion of the audio-video content identified by the selected digital ID comprises a portion of the audio-video content that advertises a selected product and retrieving, by the master service application, additional information for the selected digital ID comprises retrieving information related to the selected product.

8. The method of claim 1, further comprising monitoring the digital IDs to detect when the audio-video content relates to a registered service provider.

9. The method of claim 8, further comprising notifying the master service application in response to a detection of a digital ID that relates to the registered service provider in the step of detecting digital IDs step.

10. The method of claim 9, further comprising notifying, by the master service application, the registered service provider, triggering the registered service provider to generate a communication related to the audio-video content identified by the digital ID that relates to the registered service provider, the communication being directed to the electronic device or to a remote server.

11. The method of claim 10, wherein a selected portion of the audio-video content is identified by a selected digital ID and further wherein if the communication is directed to the electronic device, the communication comprises a call-to-action message associated with the selected portion of the audio-video content identified by the digital ID.

12. The method of claim 8, further comprising receiving, by the master service application, a deactivation signal for a given registered service provider on the electronic device, and in response to the deactivation signal the monitoring the digital IDs is not performed for the given registered service provider.

13. The method of claim 1, wherein each of the digital IDs is at least one of a fingerprint, a watermark, embedded data inside the audio-video content, and embedded data in a transmitting envelope of the audio signals.

14. An apparatus for monitoring audio-video content, the apparatus comprising:
an input for detecting audio signals of the audio-video content which comprises a digital ID;
a processing unit for decoding the digital ID;
a beacon to broadcast a presence of the apparatus to an electronic device; and
a short range wireless device to transmit the digital ID to the electronic device if the electronic device is nearby; and
wherein the apparatus is adapted to communicate with a master service application on the electronic device, the master service application being adapted to communicate with a remote backend system to retrieve additional information related to the digital ID.

15. The apparatus of claim 14, wherein the electronic device comprises an input and an application, the short range wireless device being adapted to communicate with the input of the electronic device to send the digital ID detected in the audio-video content for use by the application.

16. The apparatus of claim 14, wherein the apparatus is provided substantially as a USB peripheral.

17. The apparatus of claim 16, wherein the USB peripheral is connectable to a set-top box which manages the audio-video content in which the audio signals are detected.

18. The apparatus of claim 14, wherein the apparatus is provided as an internal part of a set-top box which manages the audio-video content in which the audio signals are detected.

19. The apparatus of claim 14, wherein the input for detecting audio signals is a microphone.

20. The apparatus of claim 19, wherein the digital ID is at least one of: a fingerprint, a watermark, embedded data inside the audio-video content, and embedded data in a transmitting envelope of the audio signals.
